(19) United States
(12) Patent Application Publication
(10) Pub. No.: US 2024/0085525 A1
(43) Pub. Date: Mar. 14, 2024

(54) METHOD AND SYSTEM FOR CLUSTERING OF POINT CLOUD DATA

(71) Applicants: HYUNDAI MOTOR COMPANY, Seoul (KR); KIA CORPORATION, Seoul (KR)

(72) Inventors: Mu Gwan Jeong, Seoul (KR); Nam Gyun Kim, Seongnam-si (KR)

(73) Assignees: HYUNDAI MOTOR COMPANY, Seoul (KR); KIA CORPORATION, Seoul (KR)

(21) Appl. No.: 18/133,173

(22) Filed: Apr. 11, 2023

(30) Foreign Application Priority Data
Sep. 8, 2022 (KR) 10-2022-0114102

(51) Int. Cl. G01S 7/48; G01S 17/89; G06F 18/241

(52) U.S. Cl. CPC G01S 7/4802; G01S 17/89; G06F 18/241

(57) ABSTRACT

A method for clustering point cloud data includes the following steps of identifying a class of each point data of the point cloud data, the class assigned according to a semantic segmentation processing of the point cloud data, storing a plurality of point data of the point cloud data in virtual layers based on the class assigned to each point data, the virtual layers each associated with at least one class; and clustering the plurality of point data for each of the virtual layers.

### CROSS-REFERENCE TO RELATED APPLICATION

The present application claims priority to Korean Patent Application No. 10-2022-0114102, filed on Sep. 8, 2022, the entire contents of which is incorporated herein for all purposes by this reference.

### BACKGROUND OF THE PRESENT DISCLOSURE

### Field of the Present Disclosure

The present disclosure relates to a method and a system for clustering point cloud data.

### Description of Related Art

For safe autonomous driving of a vehicle, accurate recognitions of the surrounding environment, i.e., the objects around the vehicle are required. In this regards, clustering LiDAR points of a point cloud obtained by a Light Detection and Ranging (LiDAR) sensor has been developed as a part of a technique for detecting an object.

In the case of a conventional clustering method which is based on 3-dimensional space information, there has been a problem of recognizing mutually different objects as one object by clustering the whole points of the objects into one cluster when the objects are adjacent to each other, for example, a vehicle and a person adjacent thereto, a building or buildings and trees adjacent thereto, etc.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing method and a system for clustering point cloud data configured for solving a problem of quality deterioration of a clustering result of the related art while providing the advantage of a real-time performance of a conventional clustering technology which is based on 3D space information.

According to an exemplary embodiment of the present disclosure, a method for clustering point cloud data includes the following steps of identifying a class of each point data of the point cloud data, the class assigned according to a semantic segmentation processing of the point cloud data, storing a plurality of point data of the point cloud data in virtual layers based on the class assigned to each point data, the virtual layers each associated with at least one class; and clustering the plurality of point data for each of the virtual layers.

The semantic segmentation processing of the point cloud data may be performed through a pre-learned deep learning network model.

The storing of the plurality of point data in the virtual layers may include associating the plurality of point data with predetermined groups based on the class assigned to each point data, the predetermined groups each associated with the at least one class, and storing the plurality of point data in the virtual layers based on a group to which each point data is associated.

The predetermined groups may include a dynamic-object group, a stationary-structure group, a drivable-area-of-a-vehicle group, and the others group.

The method for clustering point cloud data may further include generating a grid map for the plurality of point data, wherein the virtual layers are generated for each cell of the grid map.

The virtual layer of the same class may include grouping adjacent points of adjacent cells into one cluster for each of the virtual layers.

A point cloud data clustering apparatus, according to an exemplary embodiment of the present disclosure, may include an interface configured to receive point cloud data from a LiDAR sensor of a vehicle, and a processor configured to be electrically connected to or communicatively connected to the interface, wherein the processor is configured to identify a class of each point data of the point cloud data, the class assigned according to a semantic segmentation processing of the point cloud data, store a plurality of point data of the point cloud data in virtual layers based on the class assigned to each point data, the virtual layers each associated with at least one class, and cluster the plurality of point data for each of the virtual layers.

The semantic segmentation processing of the point cloud data may be performed through a pre-learned deep learning network model.

The processor may be configured to associate the plurality of point data with predetermined groups based on the class assigned to each point data, the predetermined groups each associated with the at least one class, and store the plurality of point data in virtual layers based on a group to which each point data is associated.

The predetermined groups may include a dynamic-object group, a stationary-structure group, a drivable-area-of-a-vehicle group, and the others group.

The processor may be further configured to generate a grid map for the plurality of point data, and the virtual layers are generated for each cell of the grid map.

The processor is further configured to group adjacent points of adjacent cells into one cluster for each of the virtual layers.

A method and an apparatus of clustering point cloud data according to an exemplary embodiment of the present disclosure may output a result of an accurate clustering of point cloud data even when a boundary is ambiguous or a distance between two objects is close.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram for explaining a problem of conventional clustering technology.

FIG. 2 is a block diagram of a vehicle according to an exemplary embodiment of the present disclosure.

FIG. 3 is a flowchart of an operation of a clustering system according to an exemplary embodiment of the present disclosure.

FIG. 4, FIG. 5, FIG. 6, FIG. 7 and FIG. 8 are diagrams for describing a clustering operation of a clustering system according to an exemplary embodiment of the present disclosure.

FIG. 9 is a flowchart of an operation of a clustering system according to an exemplary embodiment of the present disclosure.

FIG. 10, FIG. 11, and FIG. 12 are diagrams illustrating comparisons of clustering results of point data according to a conventional method (or system) and an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The same reference numerals refer to the same elements throughout the specification. The present specification does not describe all elements of embodiments, and known general descriptions in the field of the present disclosure of the present disclosure or repeated identical descriptions between embodiments are omitted. The term “unit,” “module,” or “device” used in the specification may be implemented by software or hardware, and according to its embodiments, a plurality of “units”, “modules”, or “devices” may be implemented as one component, or one “unit”, “module”, or “device” may include a plurality of components.

Throughout the specification, when a part is “connected” to another part, this includes not only a case where the part is directly connected, but also a case where the part is indirectly connected, and the indirect connection includes a case where the part is connected through a wireless communication network.

Furthermore, when a part “includes” a component, this means that other components may be further included rather than excluding other components unless specifically stated otherwise.

The terms “first”, “second”, and the like are used to distinguish one component from another component, and the component is not limited by the above terms.

A singular expression includes a plural expression unless there is a clear exception in the context.

In each step, the identification code is used for convenience of description and does not describe the order of each step, and each step may be performed differently from the stated order unless a specific order is clearly described in the context.

A conventional point cloud data clustering method is based on a cell that features 3D space information.

According to the conventional method, the point cloud data received from a LiDAR sensor are pre-processed and mapped to a grid map, and then, point data of cells having similar characteristics are grouped into one cluster, i.e., the point data are clustered by the characteristics of their cells.

In the conventional clustering method, when different objects are located adjacent to each other, point data of the objects are clustered as one cluster, causing a problem in the accuracy of object recognition.

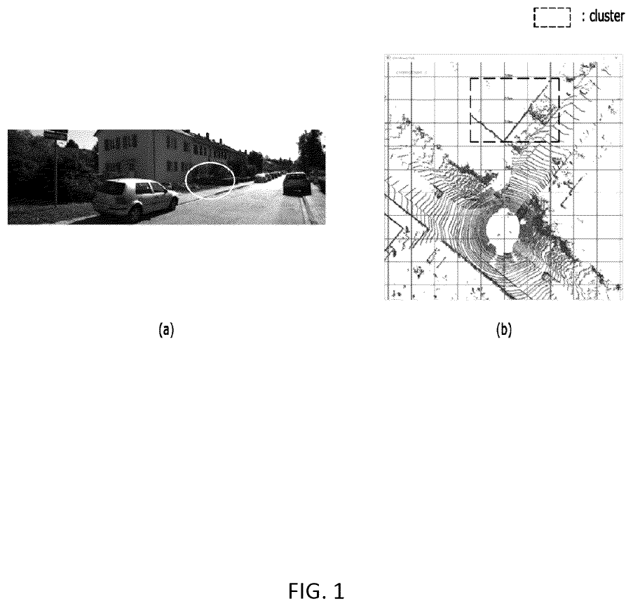

FIG. 1 is a diagram for explaining the problem of a conventional clustering method.

Referring to FIG. 1, through a LiDAR sensor, in the case of obtaining point cloud data as shown in (b) of FIG. 1 from an environment in which a wall of a building and trees are close, as shown in (a) of FIG. 1, the conventional clustering method has a problem of grouping whole point data of the wall and the trees as one cluster so that the wall and the trees are recognized as one object.

An exemplary embodiment of the present disclosure may provide a point cloud data clustering method by which point cloud data may be clustered in real time without causing the problem.

For example, a point cloud data clustering method or apparatus, according to an exemplary embodiment of the present disclosure, may assign a class to each point data based on a result of semantic segmentation performed through a deep learning network model and has an advantage of higher accuracy in real-time clustering by utilizing the class-assigned point data.

Hereinafter, various embodiments of the present disclosure will be described in detail with reference to the accompanied drawings.

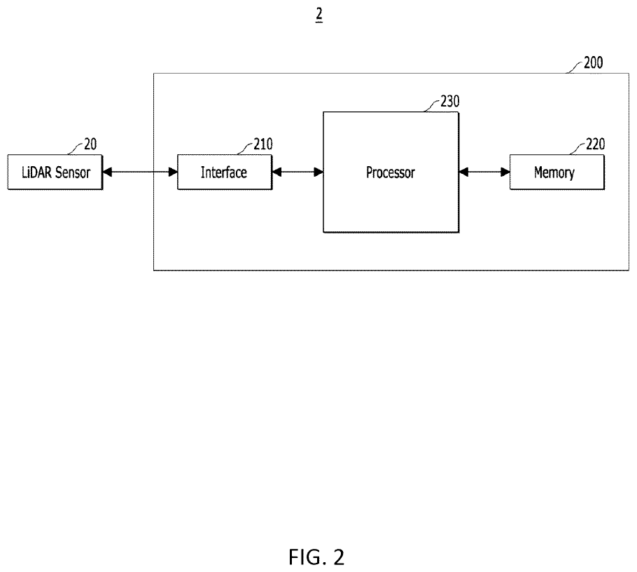

FIG. 2 is a block diagram of a vehicle according to an exemplary embodiment of the present disclosure.

The vehicle 2 may include a LiDAR sensor 20 and a clustering system (i.e., apparatus) 200.

The LiDAR sensor 20 may include one or more individual LiDAR sensors and may be mounted on an exterior of vehicle 2 to emit laser pulses toward the periphery to generate LiDAR data, i.e., point cloud data.

The clustering system 200 may include an interface 210, a memory 220, and/or a processor 230.

The interface 210 may transfer instructions or data input by a user or from other device (e.g., the LiDAR sensor 20) of the vehicle 2 to another component of the clustering system 200, or may output instructions or data received from another component of the clustering system 200 to another device of the vehicle 2.

The interface 210 may include a communication module to communicate with other devices of the vehicle 2, such as the LiDAR sensor 20.

For example, the communication module may include a communication module, which enables communication between devices of the vehicle 2, such as Controller Area Network (CAN) communication and/or Local Interconnect Network (LIN) communication through a vehicle communication network. Furthermore, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 220 may store various data used by at least one component of the clustering system 200, e.g., the input data and/or output data for a software program and commands related thereto. Also, the memory 220 may store instructions which is executable by the processor 230 for performing the functionalities thereof as described below.

The memory 220 may include a non-volatile computer-readable memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 230 (which also may be referred to as a control circuit or a control unit) may control at least one other component such as a hardware component (e.g., the interface 210 and/or the memory 220) and/or a software (e.g., a software program) of the clustering system 200 and perform various data processing and calculations.

The processor 230 may perform semantic segmentation processing on the point cloud data received from the LiDAR sensor 20.

For example, the semantic segmentation may be performed through a deep learning network model which is pre-trained. The pre-trained deep learning network model may be stored in the memory 220 or the processor 230, or may be stored in a computer system connected through the interface 210.

For example, the pre-trained deep learning network model may include a convolutional-neural-network-based model (CNN-based), and the CNN-based model may perform learning and inferential operations.

The deep learning network model may establishes already weights and biases in each layer through the pre-training by learning data.

For example, a class is assigned to each point data through the semantic segmentation of the deep learning network model. By the semantic segmentation, different classes are assigned for different classed objects.

For example, the processor 230 may control the pre-learned deep learning network model to perform semantic segmentation processing. The processor 230 may allow point cloud data to be input to the pre-trained deep learning network model for the semantic segmentation.

The deep learning network model may output point cloud data each point data of which a class is assigned to.

The processor 230 may be configured to generate a plurality of groups by grouping point cloud data based on their classes.

The processor 230 may store each of the groups in each virtual layer. For example, the processor 230 may store point data of a class, which are predetermined to be processed as the same group, in the same virtual layer, i.e., a virtual layer of the same class.

The processor 230 may be configured to generate one or more clusters by performing clustering for each virtual layer, i.e., by clustering point data in the same layer.

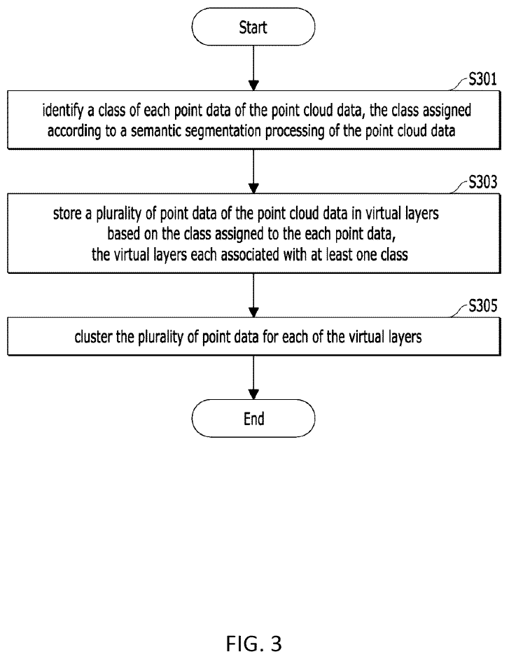

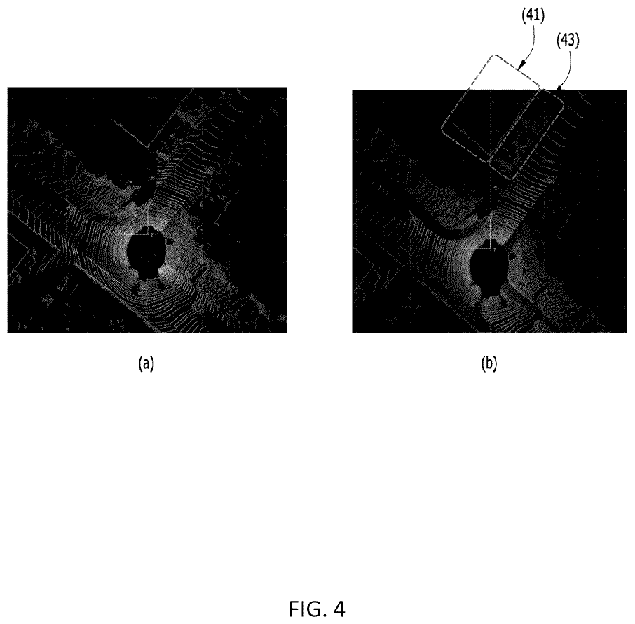

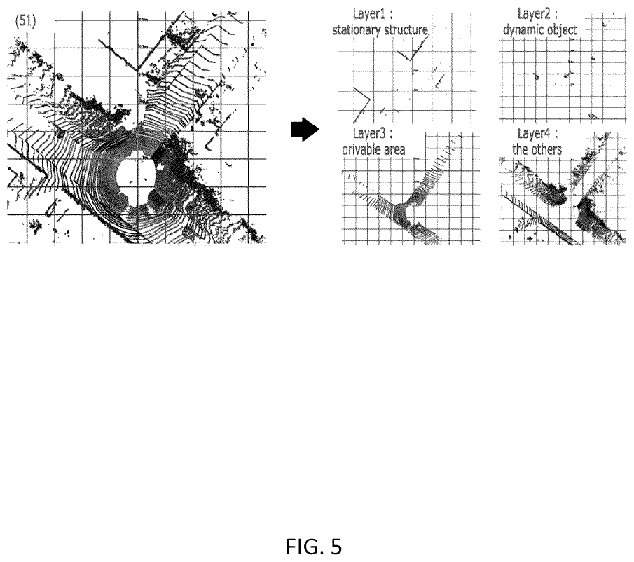

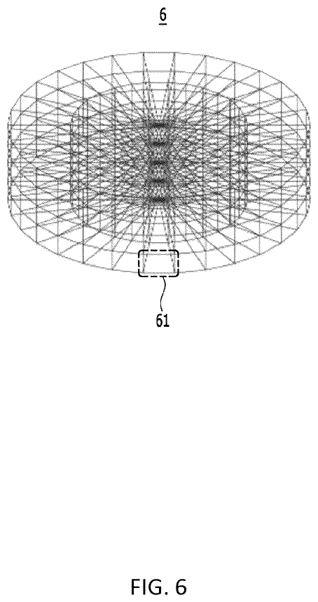

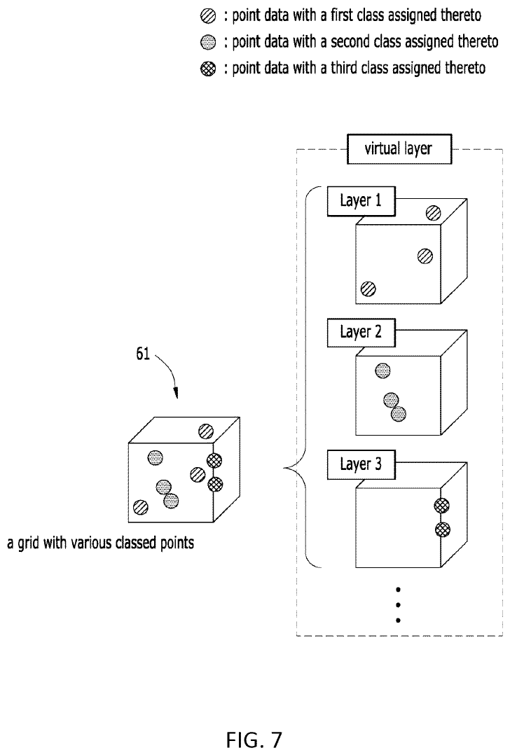

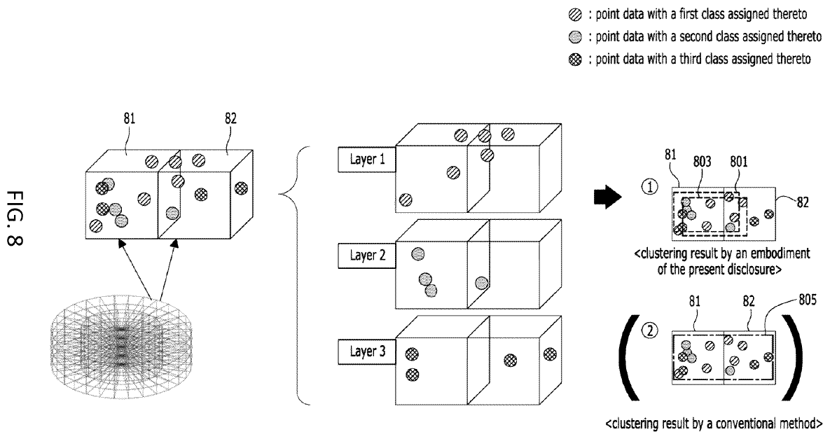

FIG. 3 is a flowchart of an operation of the clustering system 200 (and/or the processor 230) according to an exemplary embodiment of the present disclosure. FIG. 4, FIG. 5, FIG. 6, FIG. 7 and FIG. 8 are diagrams for describing a clustering process of a clustering system according to an exemplary embodiment of the present disclosure.

Referring to FIG. 3, the clustering system 200 may identify a class assigned to each point data of the point cloud data according to the semantic segmentation of the point cloud data (S301).

The clustering system 200 may receive point cloud data, such as shown in (a) of FIG. 4, from the LiDAR sensor.

The clustering system 200 may identify data resulted according to the semantic segmentation processing of point cloud data through the pre-trained deep learning network model.

The result data may include point cloud data each including an assigned class, for example, as shown in (b) of FIG. 4.

As shown like a first class being assigned to a plurality of point data 41 and a second class being assigned to a plurality of point data 43 in (b) of FIG. 4, classes may be assigned to point data differently according to their characteristics.

For example, each of the point data 41 to which the first class is assigned may refer to point data of a first object. Also, each of the point data 43 to which the second class is assigned may refer to point data of a second object. That is, different classes may be assigned for different objects.

The clustering system 200 may store a plurality of point data of the point cloud data in one of the virtual layers to which at least one class is associated based on the class assigned to each point data (S303).

The clustering system 200 may be configured to determine each of the point data to be included in one group among predetermined groups based on a class assigned to each point data. Here, each of the groups may be predetermined to be associated to at least one class.

Also, the clustering system 200 may store each of the point data in one of the virtual layers based on each group of the plurality of point data. Here, each of the virtual layers may be predetermined to be associated to one of the predetermined groups.

Accordingly, the groups that the clustering system 200 finally desires to output may be stored in one virtual layer.

For example, the predetermined groups may include a dynamic-object group, a stationary-structure group, a drivable-area-of-a-vehicle group, and/or the others group.

The dynamic-object group is for dynamic objects such as a vehicle, a powered twin wheel (PTW), a bicycle, and/or the like. The stationary-structure group is for stationary structures such as a building and/or a fence or the like. The drivable-area-of-a-vehicle group is for drivable areas such as a road and/or a parking zone. The others group is for objects not corresponding to the former 3 groups.

The stationary-structure group may be predetermined to be associated to a first class, the dynamic-object group may be predetermined to be associated to a second class, the drivable-area-of-a-vehicle group may be predetermined to be associated to a third class, and the others group may be predetermined to be associated to a fourth class.

Also, a first virtual layer (Layer 1) may be associated to the stationary-structure group, a second virtual layer (Layer 2) may be associated to the dynamic-object group, a third virtual layer (Layer 3) may be associated to the drivable-area-of-a-vehicle group, and a fourth virtual layer (Layer 4) may be associated to the others group.

In the instant case, for example, referring to FIG. 5, the clustering system 200 may store point data 51 into the virtual layers based on the class assigned to each point data.

For example, as shown in FIG. 5, point data corresponding to the stationary-structure group, i.e., a plurality of point data to which the first class is assigned, may be stored in the first virtual layer (Layer 1). Point data corresponding to the dynamic-object group, i.e., a plurality of point data to which the second class is assigned, may be stored in the second virtual layer (Layer 2). Point data corresponding to the drivable-area-of-a-vehicle group, i.e., a plurality of point data to which the third class is assigned, may be stored in the third virtual layer (Layer 3). Point data corresponding to the others group, i.e., a plurality of point data to which the fourth class is assigned, may be stored in the fourth virtual layer (Layer 4).

The above-described virtual layers may be included in each cell of a grid map. The virtual layers are used to store various classed point data of a cell of the grid map separately by their characteristics (e.g., dynamic objects, buildings, fences, and the like).

A grid map may be generated according to a conventional method, however, each cell includes virtual layers as described above according to an exemplary embodiment of the present disclosure.

For example, the generation of a grid map may be performed by the clustering system 200 after the semantic segmentation of the point cloud data, e.g., after S301.

Also, the form of the grid map may be one of various conventional grid maps, e.g., the 2.5D grid map 6 as shown in FIG. 6.

Referring to the first cell 61 of the 2.5D grid map 6 of FIG. 6 as an explanation, the first cell 61 may include virtual layers such as, e.g., a first virtual layer (Layer 1), a second virtual layer (Layer 2), and/or a third virtual layer (Layer 3) as shown in FIG. 7.

Also, the first class may be associated to the first virtual layer (Layer 1), a second class may be associated to the second virtual layer (Layer 2), and a third class may be associated to the third virtual layer (Layer 3).

In the instant case, referring to FIG. 7, the clustering system 200 may store the three point data in the first virtual layer (Layer 1) of the first cell 61 since the first class is assigned to the three point data.

Also, since the second class is assigned to another three point data in the first cell 61, the clustering system 200 may store the second-classed three point data in the second virtual layer (Layer 2) of the first cell 61.

And also, since the two point data to which the third class is assigned are not located in the first cell 61 but are located at the boundary of the first cell 61, the clustering system 200 may not store the two point data in the third virtual layer (Layer 3) of the first cell 61.

To determine whether each point data is located in a cell, the clustering system 200 may use the coordinate information of the point data.

The clustering system 200 may cluster a plurality of point data which are stored in a virtual layer by grouping points adjacent to each other into one cluster (S305).

When the plurality of point data clustered, the virtual layers of a same class of adjacent cells may be considered together.

Referring to FIG. 8, according to the above-described operations, among point data in a second cell 81 of the 2.5D grid map 6, the point data to which the first class is assigned, the point data to which the second class is assigned, and the point data to which the third class is assigned may be stored in the first virtual layer (Layer 1), the second virtual layer (Layer 2), and the third virtual layer (Layer 3) of the second cell 81, respectively.

Also, the point data to which the first class is assigned, the point data to which the second class is assigned, and the point data to which the third class is assigned in a third cell 82 adjacent, i.e., immediately next to the second cell 81, may be stored in the first virtual layer (Layer 1), the second virtual layer (Layer 2), and the third virtual layer (Layer 3) of the third cell 82, respectively.

In a state in which a plurality of point data are stored in virtual layers as shown in FIG. 8, the clustering system 200, according to an exemplary embodiment of the present disclosure, may be configured to generate a cluster 801 as having the point data to which the first class is assigned in the second and third cells 81, 82, and a cluster 803 as having the point data to which the second class is assigned in the cells as shown in \textcircled{1}. Also, the point data to which the third class is assigned in the cells may be determined not to be adjacent to each other and thus may not be determined to belong to the same cluster.

Also, according to a conventional method, as shown in \textcircled{2}, all point data included in the second cell 81 and the third cell 82 may be determined to belong to one cluster 805.

Due to, as in the exemplary embodiments of the present disclosure, virtual layers being used for clustering point cloud data, it is possible to prevent different objects from being determined as one cluster, and at the same time, it is possible to determine whether to cluster a plurality of point data by reflecting characteristics of 3D spatial information of the point data included in each of the virtual layers. Accordingly, various embodiments of the present disclosure may improve the quality of the clustering result based on the characteristics of the point data.

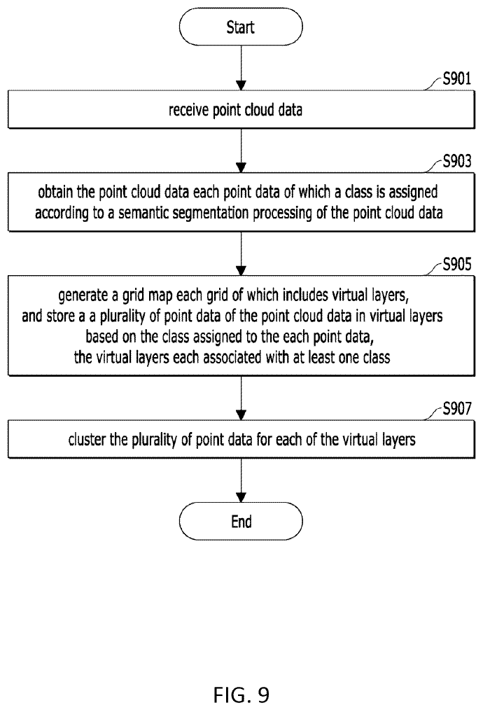

FIG. 9 is a flowchart of operations of the clustering system 200 (and/or the processor 230) according to an exemplary embodiment of the present disclosure.

Referring to FIG. 9, the clustering system 200 may receive point cloud data from the LiDAR sensor 20 (S901).

The clustering system 200 may obtain point cloud data each including a class which is assigned to each point according to a semantic segmentation processing of the point cloud data through the deep learning network model (S903).

The clustering system 200 may input point cloud data to the deep learning network model to obtain the point cloud data each including the class output from the deep learning network model.

The clustering system 200 may be configured to generate a grid map including virtual layers for each cell, and may store point data to which a class is assigned in the corresponding virtual layer (S905).

The clustering system 200 may perform clustering of point data adjacent to each other within adjacent cells for each virtual layer (S907).

Since the detailed embodiments of operations S905 and S907 have been described in detail with reference to FIGS. 3 and 5 to 8, the repeated description thereof is omitted.

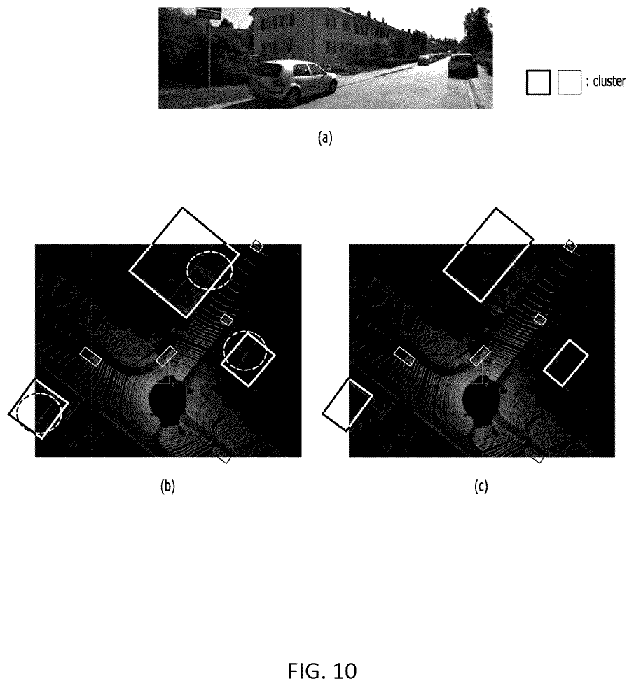

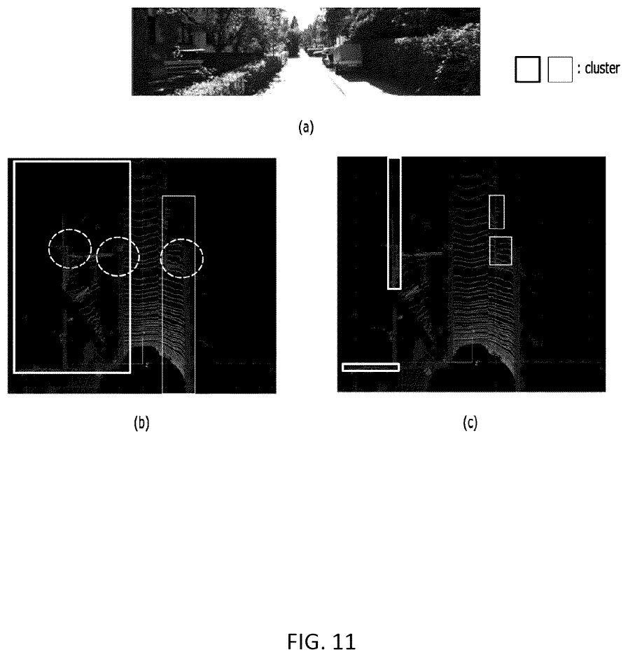

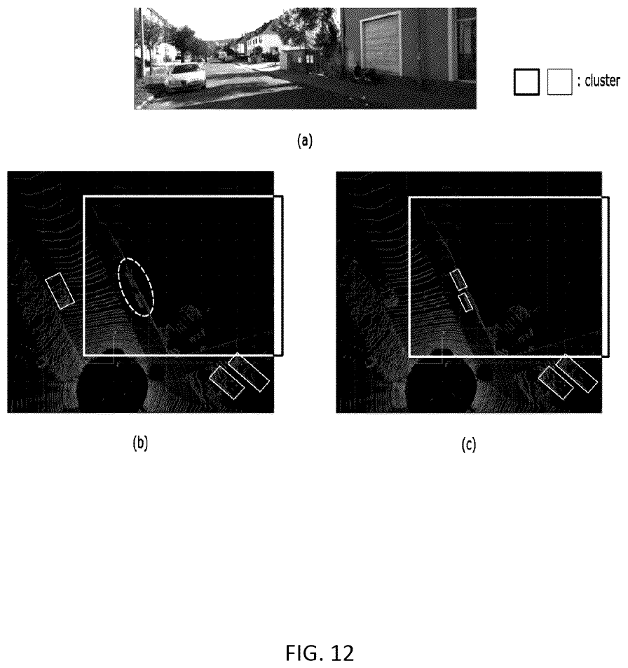

FIG. 10, FIG. 11, and FIG. 12 are illustrating comparisons of clustering results of the related art and an exemplary embodiment of the present disclosure.

In the case of an environment in which there is a building and trees adjacent to the building as shown in (a) of FIG. 10, the clustering system according to the exemplary embodiment outputs different clusters for the point data of the building and the point data of the trees as shown in (b) of FIG. 10, whereas the conventional clustering system outputs all point data of the building and the trees as one cluster as shown in (b) of FIG. 10.

Also, in the case of an environment in which there are trees adjacent to a vehicle and a building, and other objects, the conventional clustering system outputs point data of different objects as one cluster as shown in (b) of FIG. 11, while the clustering system according to the exemplary embodiment outputs different clusters for different objects as shown in (c) of FIG. 11.

Furthermore, in the case of an environment in which there are a bicycle and a motorcycle adjacent to a building as shown in (a) of FIG. 12, the conventional clustering system outputs point data of all of the building, the bicycle, and the motorcycle as one cluster as shown in (b) of FIG. 12, while the clustering system according to the exemplary embodiment outputs different clusters for different objects as shown in (c) of FIG. 12.

In other words, the clustering according to an exemplary embodiment of the present disclosure may produce a relatively more accurate result even when boundaries between objects are ambiguous or the distance is close.

An exemplary embodiment of the present disclosure may be implemented in a form of a recording medium for storing instructions executable by a computer. The instructions may be stored in a form of a program code, and when executed by a processor, may perform operations of the disclosed exemplary embodiments of the present disclosure. The recording medium may be implemented as a non-transitory computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, etc.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for clustering point cloud data which is performed by a processor executing instructions stored in a non-transitory computer-readable storing medium, the method comprising:
identifying, by the processor, a class of each point data of the point cloud data, wherein the class is assigned according to a semantic segmentation processing of the point cloud data;
storing, by the processor, a plurality of point data of the point cloud data in virtual layers based on the class assigned to each point data, wherein each of the virtual layers is associated with at least one class; and
clustering, by the processor, the plurality of point data for each of the virtual layers.

2. The method of claim 1, wherein the semantic segmentation processing of the point cloud data is performed through a pre-trained deep learning network model.

3. The method of claim 1, wherein the storing of the plurality of point data in the virtual layers includes:
associating the plurality of point data with predetermined groups based on the class assigned to each point data, the predetermined groups each associated with the at least one class; and
storing the plurality of point data in the virtual layers based on a group to which each point data is associated.

4. The method of claim 3, wherein the predetermined groups include a dynamic-object group, a stationary-structure group, a drivable-area-of-a-vehicle group, and the others group.

5. The method of claim 1, further including: generating a grid map for the plurality of point data, wherein the virtual layers are generated for each cell of the grid map.

6. The method of claim 5, wherein the clustering of the plurality of point data includes grouping adjacent points of adjacent cells into one cluster for each of the virtual layers.

7. An apparatus of clustering point cloud data, the apparatus comprising:
an interface configured to receive point cloud data from a Light Detection and Ranging (LiDAR) sensor of a vehicle; and
a processor configured to be electrically connected to or communicatively connected to the interface,
wherein the processor is configured to:
identify a class of each point data of the point cloud data, the class assigned according to a semantic segmentation processing of the point cloud data,
store a plurality of point data of the point cloud data in virtual layers based on the class assigned to each point data, the virtual layers each associated with at least one class, and
cluster the plurality of point data for each of the virtual layers.

8. The apparatus of claim 7, wherein the semantic segmentation processing of the point cloud data is performed through a pre-trained, deep learning network model.

9. The apparatus of claim 7, wherein the processor is further configured to:
associate the plurality of point data with predetermined groups based on the class assigned to each point data, the predetermined groups each associated with the at least one class; and
store the plurality of point data in virtual layers based on a group to which each point data is associated.

10. The apparatus of claim 9, wherein the predetermined groups include a dynamic-object group, a stationary-structure group, a drivable-area-of-a-vehicle group, and the others group.

11. The apparatus of claim 7, wherein the processor is further configured to generate a grid map for the plurality of point data, and the virtual layers are generated for each cell of the grid map.

12. The apparatus of claim 11, wherein the processor is further configured to group adjacent points of adjacent cells into one cluster for each of the virtual layers.
